(19) United States
(12) Patent Application Publication
(10) Pub. No.: US 2002/0010674 A1
(43) Pub. Date: Jan. 24, 2002

(54) Method of providing tax credits and property rental and purchase

(76) Inventor: Carl E. Kent, Fridley, MN (US)

Correspondence Address: DORSEY & WHITNEY LLP, 50 SOUTH SIXTH STREET, MINNEAPOLIS, MN, 55402-1498, US

(21) Appl. No.: 09/843,191

(22) Filed: Apr. 26, 2001

Related U.S. Application Data
(60) Provisional application No. 60/224,198, filed on Aug. 9, 2000.
(60) Provisional application No. 60/207,492, filed on May 26, 2000.

(51) Int. Cl. G06F 17/60

(52) U.S. Cl. 705/37; 705/14; 705/26

(57) ABSTRACT

The present invention offers a comprehensive distribution system for tax credits and property rental and purchase, that allows corporate, institutional, and individual investors to compete for the purchase of tax credits attached to real estate offered by the issuer, by facilitating tax credit trading into specialized markets, and allows prospective renters and purchasers to search through available single family and multi-family dwellings, and do business with the seller/owner.

### CLAIM OF PRIORITY

This application claims priority of U.S. Provisional Patent Application Serial No. 60/207,492, filed May 26, 2000, entitled “METHOD OF PROVIDING TAX CREDITS AND PROPERTY RENTAL AND PURCHASE” by Carl E. Kent, and U.S. Provisional Patent Application Serial No. 60/224,198, filed Aug. 9, 2000, entitled “METHOD OF PROVIDING TAX CREDITS AND PROPERTY RENTAL AND PURCHASE” by Carl E. Kent, both of which are herein incorporated by reference in their entirety.

### BACKGROUND

Tax credits are incentives offered by either the federal or state governments to induce contributions and investments from the private sector into projects that benefit distressed communities and populations. A tax credit results in a reduction of taxpayer liability in the jurisdiction issuing the credit, by allowing tax payers to re-direct their state and/or federal taxes to community or economic development projects approved by the issuing authority. Tax credit issuers include several agencies of the United States federal government (HUD, Dept. of Agriculture, etc.), as well as state and local governments. Institutional buyers and sellers include banks, insurance companies, real estate developers and managers, Fortune 500 corporate treasury departments, and financial services firms.

A key factor in the popularity of tax credit related properties, is the Community Reinvestment Act (“CRA”). The CRA was enacted as part of the 1986 Tax Reform Act, and is a federal law requiring banks to channel a portion of their lending to low income communities. In addition to federal tax credits, states are beginning to approve tax credits for historic renovation. Also, some states now permit local government to offer property tax abatement to owners who rehabilitate historic structures.

The primary difficulty with these tax programs, is that tax credits allocated to projects may remain unclaimed by investors and contributors. Unclaimed tax credits arise largely from holders having insufficient income against which to offset the tax credit, thereby permitting the tax credit to expire. One feature of tax credits, is that they may be sold to other entities that have income tax obligations in the same jurisdiction in which the credits were issued. For instance, if a developer were to be allocated X amount of tax credits for a project, the developer has the choice to either use the credits against income tax obligations, or to sell the credits to a buyer who would pay Y cents to the dollar for the credits. The developer could then use the capital raised from that sale to help finance the project.

One of the problems facing this issue, is that currently there is a long lead time in disseminating information about the availability of tax credit programs, including restricted access to such information. Because tax credits have a limited life and are perishable, delayed and limited disclosure creates a lag in program delivery and results in tax credit “inventory spoilage.” There is currently no organized secondary market to provide a place where buyers and sellers can come together to trade tax credits.

Thus, what is needed, is an organized secondary market where buyers and sellers can come together to trade tax credits.

Currently in the financial markets, trading practices have many drawbacks. In the secondary market for municipal bonds, for example, there are many factors that make this form of trading undesirable. One factor is that bidders are not allowed to see either their status relative to other bidders, or other bids. The bidder is operating in a “blind pool” or a vacuum. Also, the current trading process for municipal bonds only allows for one bid per bidder. The bidder cannot revise their bid in reaction to the market prior to acceptance of a bid by the issuer. A third factor, is that only large national players are allowed to participate. Smaller firms with less capital are not able to participate in the process. A fourth factor, is that the current process depends on unreliable fax transmissions to confirm trade information.

Thus, what is needed, is a secondary trading system that allows bidders to see other bids, make more than one bid, allows smaller firms to participate, and uses a reliable form of communication to confirm trade information.

People searching for affordable housing encounter many problems. One problem is that it can take weeks or months to gather, analyze, and shortlist available options. By the time this is done, some of the properties are already rented out or sold. Another problem is the volume. Currently, manual efforts to track information on affordable housing cannot keep up with the volume and frequency of new listings and changing occupancy levels. These current manual methods are not practical for up-to-the-minute comparisons. It is very time consuming, and impractical to integrate buyer criteria with seller profiles and pricing, and the paper files can become an administrative headache to manage.

Some existing concepts to address this problem include RealEstate.com, bhg-real-estate.com, and Home-Advisor.msn.com. These are Internet web services that provide users with an array of search options to find single family housing listings. The sites provide users with properties matching their search criteria. The sites also provide users with an online mortgage calculator and equity analysis tools to help users figure out their financing options. However, a vast majority of the properties listed are existing sites. There are very few new construction properties listed on these sites. Also, the sites do not furnish information on multi-family dwellings, nor do they cater to the specific needs of low and moderate income individuals. Furthermore, these sites are strictly developed around a business to consumer model. There is no business to business model. Also, the sites do not facilitate online transactions, such as buy/sell auctions or the making of lease applications.

Other online services, such as Apartments.com, and ApartmentGuide.com, provide users with search options to find apartment listings by specifying certain criteria, such as state, rental price, number of bedrooms, number of bathrooms, and amenities. The sites present users with matching properties from which the user selects one or more properties for additional detail, including contact name, area maps, and more. However, these sites only list existing sites. No new construction properties are listed. Also, these sites do not furnish information on single family housing listings, which includes town homes and quad homes. Nor do these sites cater to the needs of low and moderate income individuals. These sites are also developed around a business to consumer model. There is no business to business model. Finally, these sites do not facilitate online transactions such as the making of a lease application.

Thus, what is needed, is a simplified, time efficient, methodology for consumers or prospective tenants to accurately gather, analyze, and shortlist options based on a tailored list of criteria, and where a consumer's search is conducted online and is easily integrated with seller property profiles and pricing, making it easy to compare needs to the available housing inventory.

### SUMMARY

The present invention offers a comprehensive distribution system for tax credits and property rental and purchase, that allows corporate, institutional, and individual investors to compete for the purchase and sale of tax credits attached to real estate offered by the issuer, by facilitating tax credit trading into specialized markets, and allowing prospective renters and purchasers to search through available single family and multi-family dwellings, and do business with the seller/owner.

The system of the present invention provides online research of a variety of investment property highlights, including local housing finance agency project numbers, development names and cities, the owner or contact of the housing tax credits requested and the housing tax credits awarded, all in one location. There are also listings for tax credit based commercial properties such as those located in federally recognized empowerment zones. The system of the present invention is a secondary market or clearinghouse for buyers and sellers to come together to trade tax credits in an efficient and profitable manner. Bidders are allowed to bid more than once and are allowed to see the latest bids after having had an opportunity to research the properties related to the tax credits, and speak with the seller or buyer via an on-line connection.

In the system of the present invention, information search efforts are simplified. The system of the present invention is a time efficient methodology for the astute buyer or renter to accurately gather, analyze, and shortlist options based on a tailored set of criteria. The search is conducted on-line with information accurately and instantaneously retrieved. A buyer or renter's criteria template is formed on-line and is easily integrated with seller property profiles and pricing. This makes for easy comparison of needs versus available inventory of tax credits and/or housing. There is no paperwork nightmare. A user could electronically go through the criteria template and download the results into their hard drive for storage, future retrieval, or printing of pertinent details. In the system of the present invention, buyers can find housing and tax credits that best fit their needs, and can reduce time by conducting a majority of their business on-line. In the system of the present invention, buyers and sellers of tax credits can also register their tax credit ownership transfer on-line, saving significant time. Similarly, prospective tenants can fill out housing applications on-line. Advertisers can create hotlinks to their web sites for additional information, and for on-line sales. Owners of investment properties can create and update customized listings of their property, and have this information available to users 24 hours a day and 7 days a week.

### BRIEF DESCRIPTION OF THE DRAWINGS

FIG. 1 is a flow diagram of one embodiment of the present invention which allows a user to interface with a remote server in order to access the system of the present invention.

FIG. 2 is a flow diagram of one embodiment of the overall system of the present invention.

FIG. 3 is a flow diagram of one embodiment of the communication section of the present invention.

FIG. 4 is a flow diagram of one embodiment of the research bank section of the present invention.

FIG. 5 is a flow diagram of one embodiment of the electronic marketplace section of the present invention.

FIG. 6 is a flow diagram of one embodiment of the commercial transaction section of the electronic marketplace section of the present invention.

FIG. 7 is a flow diagram of one embodiment of the commercial transaction section where buyers and sellers can list investment information.

FIG. 8 is a flow diagram of one embodiment of the commercial transaction section where buyers and sellers can search for available tax credit sale or purchase opportunities.

FIG. 9 is a flow diagram of one embodiment of the present invention which allows users to calculate a tax credit indexed price in the commercial transaction section.

FIG. 10 is a flow diagram of one embodiment of the present invention which allows users to link from the commercial transaction section to other related sites.

FIG. 11 is a flow diagram of one embodiment of the present invention which allows a user to place a straight or reverse bid on tax credits in the commercial transaction section.

FIG. 12 is a flow diagram of one embodiment of the consumer information section of the electronic marketplace section of the present invention.

FIG. 13 is a flow diagram of one embodiment of the present invention which allows users to search for property listings in the consumer information section.

FIG. 14 is a flow diagram of one embodiment of the present invention which allows users to link from the consumer information section to related sites.

FIG. 15 is a flow diagram of one embodiment of the general information section of the present invention.

### DETAILED DESCRIPTION

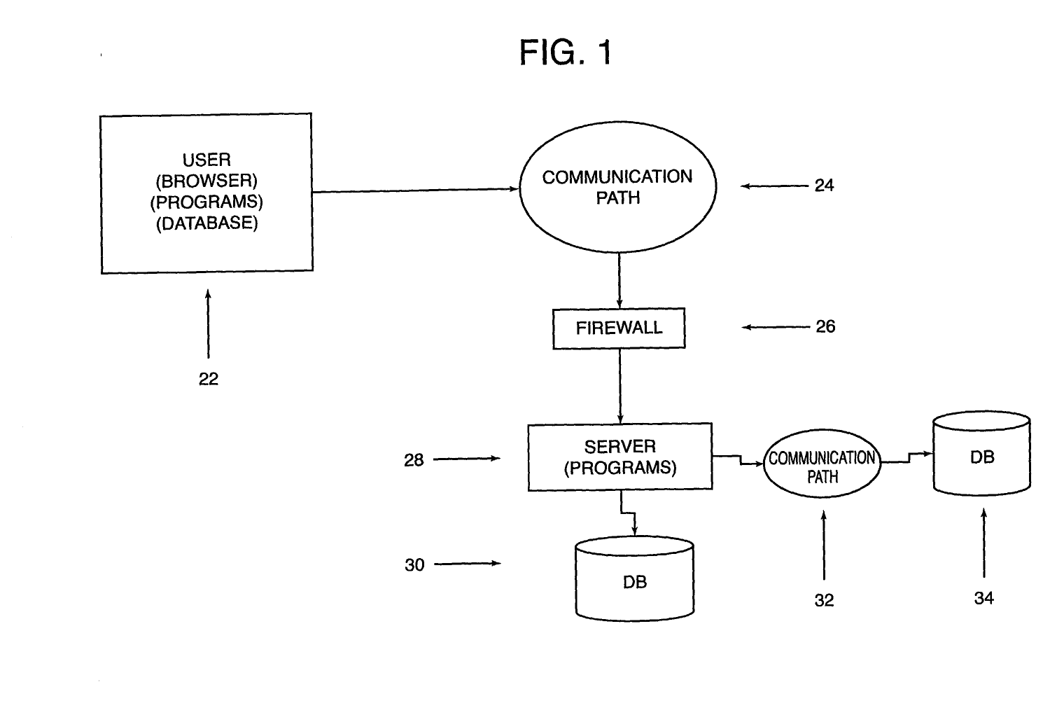

As shown in FIG. 1, in one embodiment of the present invention, a user may access the system of the present invention via a computer 22 connected to a remote server 28 via a communication path 24. The system of the present invention may operably be carried out by software operable on the remote server 28. This software allows the user to participate in a tax credit auction, access tax credit-related information, or search for available property for sale or rent. In order to carry out the system of the present invention, the software may access information stored on databases 30 on the same remote server 28 as the software, or the software may access information stored on databases 34 on other remote servers via a communication path 32. The buyers and sellers may, in one embodiment, communicate with the server 28 over a communication path 24, which may be a direct dial connection, Intranet, Extranet, the Internet or World Wide Web (“WWW”), or other suitable telecommunications paths. A suitable network protocol, such as the TCP/IP protocol, may be used for the communications. Communications may also be done in one embodiment of the invention by voice interactive technology known in the art or by pushbutton commands.

The communication paths 24 and 32 used within the scope of the invention may be any known type of communication path, such as, a Local Area Network (“LAN”) of any type, a Wide Area Network (“WAN”), a private network, or a public network including the Internet and the Web.

The client computer 22 or customer may be any computer or computers used by those skilled in the art, and such client computers 22 may allow remote users to access the system of the one embodiment of the invention in order to search for available properties or tax credits. The client computer 22 may comprise a central processor unit (“CPU”) and main memory, an input/output interface for communicating with various databases, files, programs, and networks (such as the Internet), and one or more storage devices. The storage devices may be disk drive devices or CD ROM devices. The client computer 22 may also have a monitor or other screen device and an input device, such as a keyboard or a mouse. In order to carry out the present invention over the Internet, the client computer may also have some software programs contained in the main memory or the storage devices which can be used by the CPU. In one embodiment of the present invention, a Web browser, which is a known software tool used to access the Web via a connection obtained through an Internet access provider, may be part of the software programs on the client computer 22. A variety of browsers known to those skilled in the art may be used within the scope of the present invention, including Netscape Navigator, Microsoft Internet Explorer, or Mosaic browsers. The central processing unit may use the browser software package to interpret the information and display it on a monitor.

The server 28 may comprise Web servers and application servers or any combination thereof, and may be any computer known to those skilled in the art. The Web servers and the application servers can be separate entities, or may exist within a single computer or computer system. This specification will refer to both possibilities as remote server 28. The server 28 allows access by the buyers and sellers to various network resources. FIG. 1 illustrates one possible configuration of the server 28 of an embodiment of the invention, although any type of configuration known to those skilled in the art may be used. As FIG. 1 depicts, the external server may be separated and protected from the WWW by a firewall 26, which may be any common or custom firewall known to those skilled in the art. The server 28 may also have access, via direct dial or the Internet, to external data sources.

### Overall System

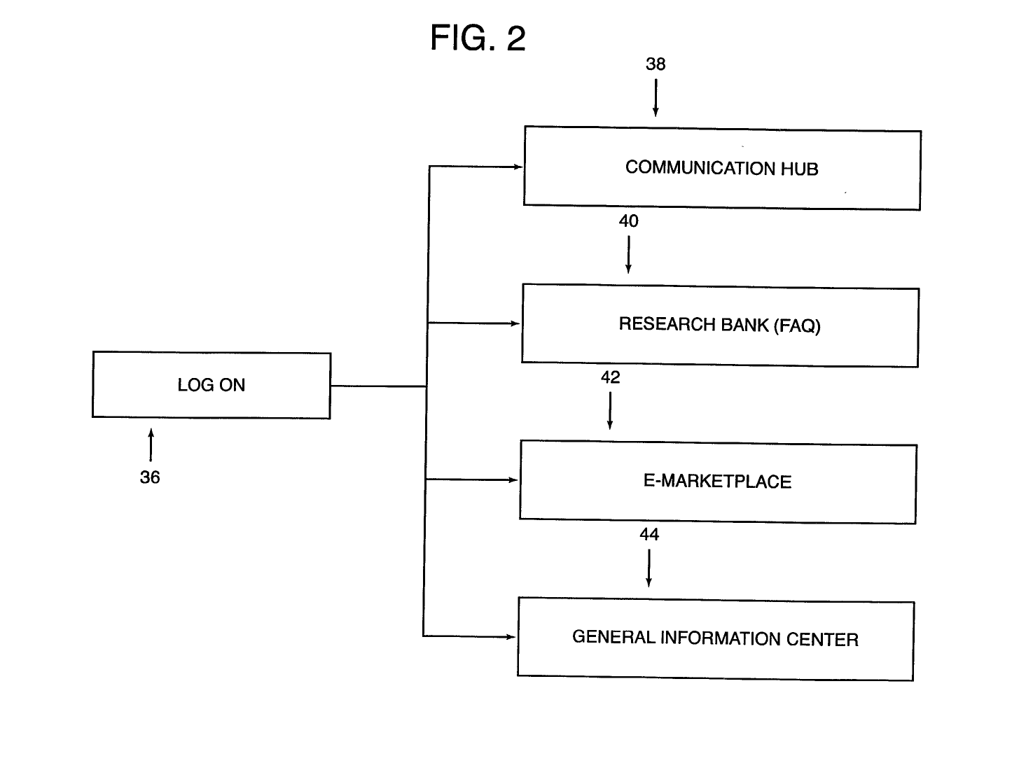

In FIG. 2, one embodiment of the overall system of the present invention is shown. In this embodiment, a user may be confronted with a number of options after connecting, or logging on, to the system 36. Several options may be presented in order to help the user easily navigate the site and access information. In one embodiment, the user may be confronted with four initial options. These options could be: communication hub 38, which could facilitate communications between buyers, sellers, tenants, owners, and clearinghouse entities via many different methods; a research bank 40, which could allow a user to find out information regarding the web site, or what it is about; an e-marketplace 42, which could allow a user to search for available properties or tax credits, do research, and conduct any business; and a general information center 44, in which a user could look at related articles or leasing information. These options are exemplary, and should not be used to restrict the scope of the invention.

### Communication Section

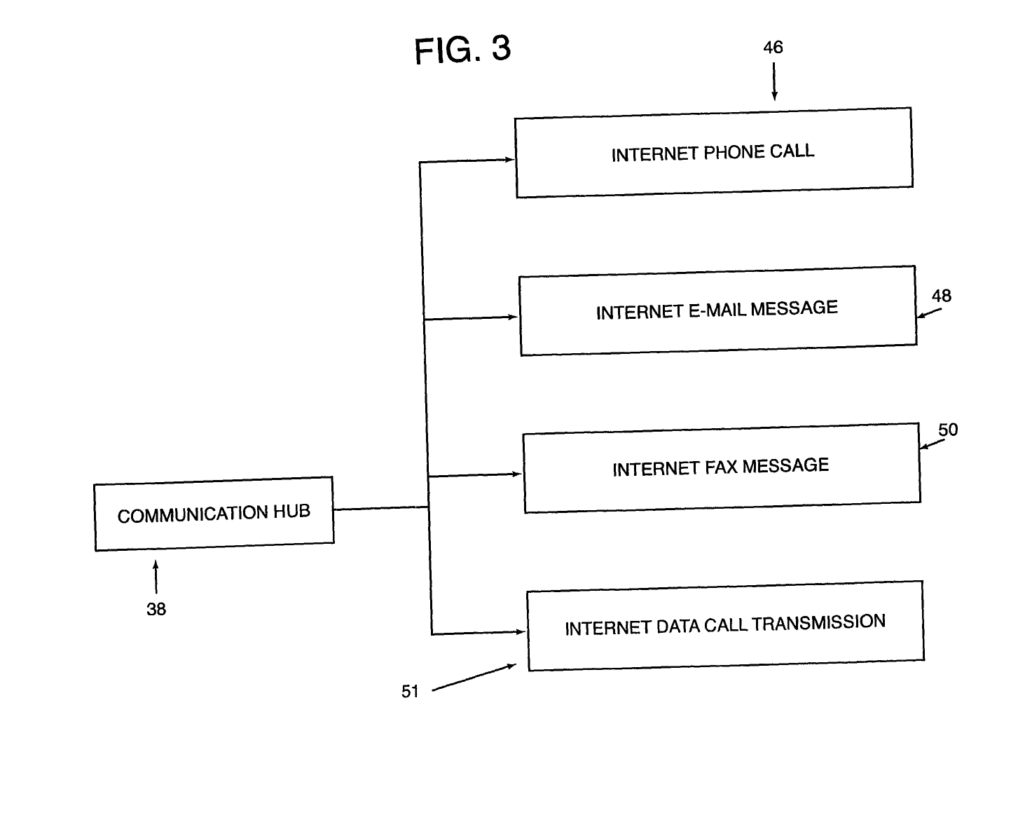

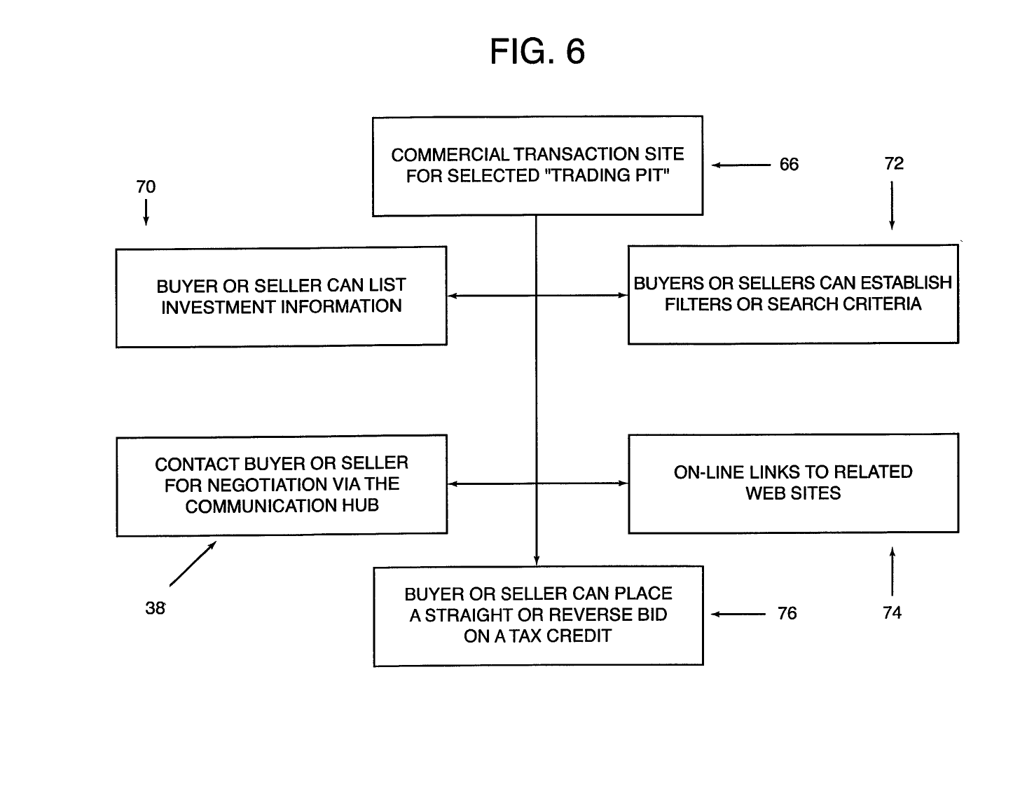

FIG. 3 shows one embodiment of the present invention in which a user may contact a seller, buyer, tenant, or owner for negotiation 38. This option may be presented initially when the user enters the site as shown in FIG. 2, and links back to this section of the site may be present in the commercial transaction and consumer information sections of the e-marketplace 42, as shown in FIGS. 6, 8, 11, 12, and 13. The option to communicate with another party allows a user to select one of four ways to make contact via an online link. In one embodiment, the user can select to dial up a voice over the Internet phone call to the party's phone number which resides on the system 46, or may dial up and send to the party's e-mail address a brief custom message 48, or may dial up and send to the party's fax over the Internet, a brief custom message 50, or may dial up and perform a data call transmission with a clearinghouse entity 51. In one embodiment, if a user attempts to contact a party via an Internet phone call 46, and is not able to make contact, the server 28 may send an alert email message to the party, notifying them that a prospective buyer, seller, or tenant has tried to contact them.

### Research Bank Section

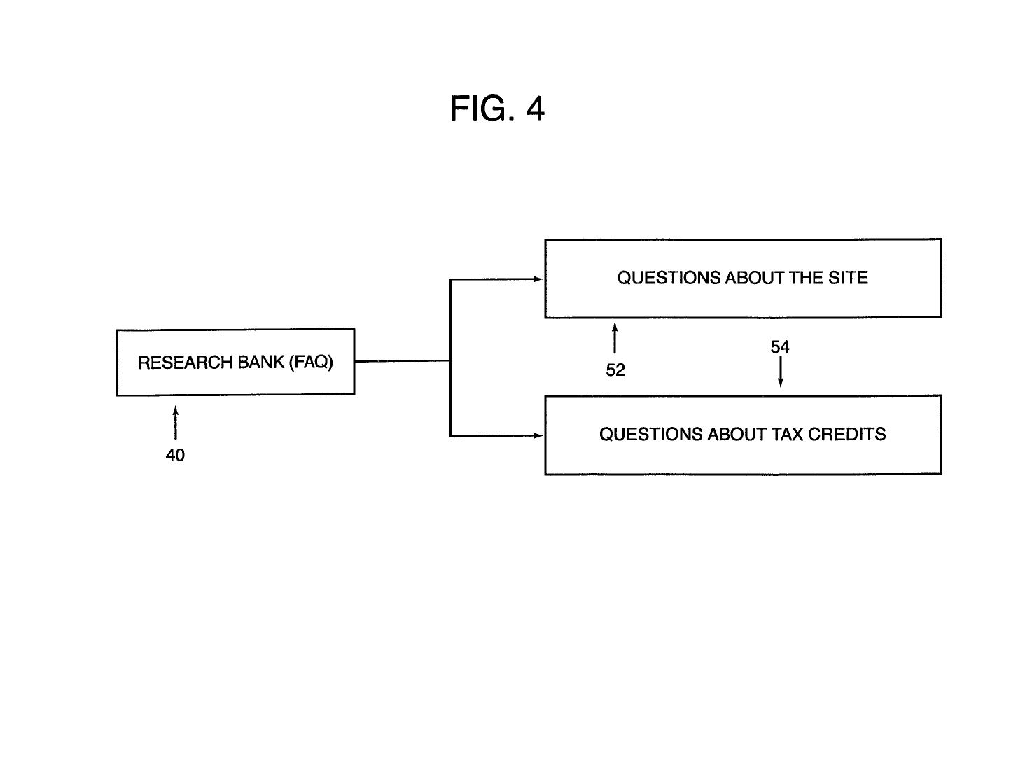

FIG. 4 shows one embodiment of the present invention in which a user may gain general information. In one embodiment, a user selecting the research bank option 40 at the site entry point as shown in FIG. 2, could be given two options. One option could be to go to questions about the site 52. This could be similar to a “Frequently Asked Questions” area, in which many points of general information regarding the site, i.e., how it works, what it does, how it can help you, how you may contact the site administrator, etc., is available. Another option presented to a user, could be to go to questions about tax credits 54. This section could also be a “Frequently Asked Questions” area, in which many points of general information regarding tax credits, i.e., what they are, how they work, why they are bought and sold, who buys and sells the, etc., is available. These options are exemplary, and should not be used to restrict the scope of the invention.

### E-Marketplace

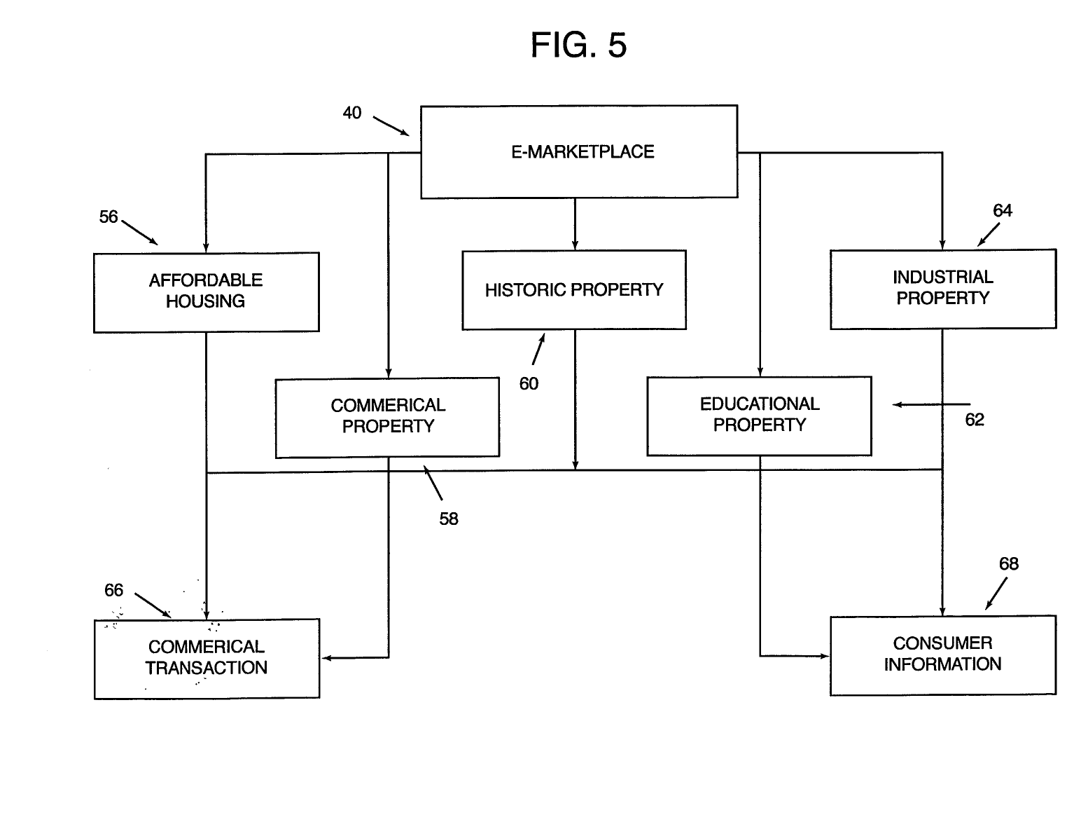

FIG. 5 is one embodiment of the present invention, in which a user can access the e-marketplace 40 from the initial options presented at the site, as shown in FIG. 2. In one embodiment, after selecting the e-marketplace option 40, the user could be presented with the different areas of real estate, or “trading pits” that they might want to access in order to gather information and/or conduct business regarding tax credits or housing. In this embodiment, the user is confronted with five options; Affordable housing 56, Commercial property 58, Historic property 60, Educational property 62, and Industrial property 64. These five options are exemplary, and should not be used to restrict the scope of the invention. Other areas of real estate may also be used. In this embodiment, once the desired category has been selected, the user may be presented with two options. These two options are to go to a commercial transaction section 66 of the site, or to a consumer information section 68.

In the commercial transaction section 66, the user may gather information regarding available tax credits and investment properties as well as information regarding prospective buyers looking for tax credits, from around the country for the selected trading pit. The user may also conduct business in this section, in the form of buying or selling tax credits in an auction format. In the consumer information section 68, the user can gather information regarding available housing and properties from around the country. The user may also conduct business in this section, in the form of buying or selling property, or advertising and leasing rental property.

### Commercial Transaction Section

In FIG. 6, one embodiment of the commercial transaction section of the present invention is shown. Once the user has selected a specific trading pit, they could select the commercial transaction section 66. In one embodiment of the invention, a password may be required, so that only those who have paid a set fee, or registered with the service may access the commercial transaction section. Once the commercial transaction section 66 has been selected, the user can be presented with options. One example of possible options is shown in FIG. 6. These options are: a seller or buyer may list investment information 70, a prospective buyer or seller can establish a filter or search criteria 72, a prospective buyer or seller can contact a buyer or seller for negotiations via the communication hub 38, the user may select an online link to selected web sites 74, or a prospective buyer or seller may place a straight or reverse bid on tax credits 76. In this specification, the term “straight bid” means a bid made by a buyer for a seller's product, and the term “reverse bid” means a seller bidding to sell a product to a buyer who has indicated a desire for a certain product. In a reverse bid, sellers tell the buyer at what price they are willing to sell a product. In a reverse bid situation, the seller offering the product at the lowest price usually wins the buyer's business. In a straight bud situation, the buyer offering the highest price for the product usually wins.

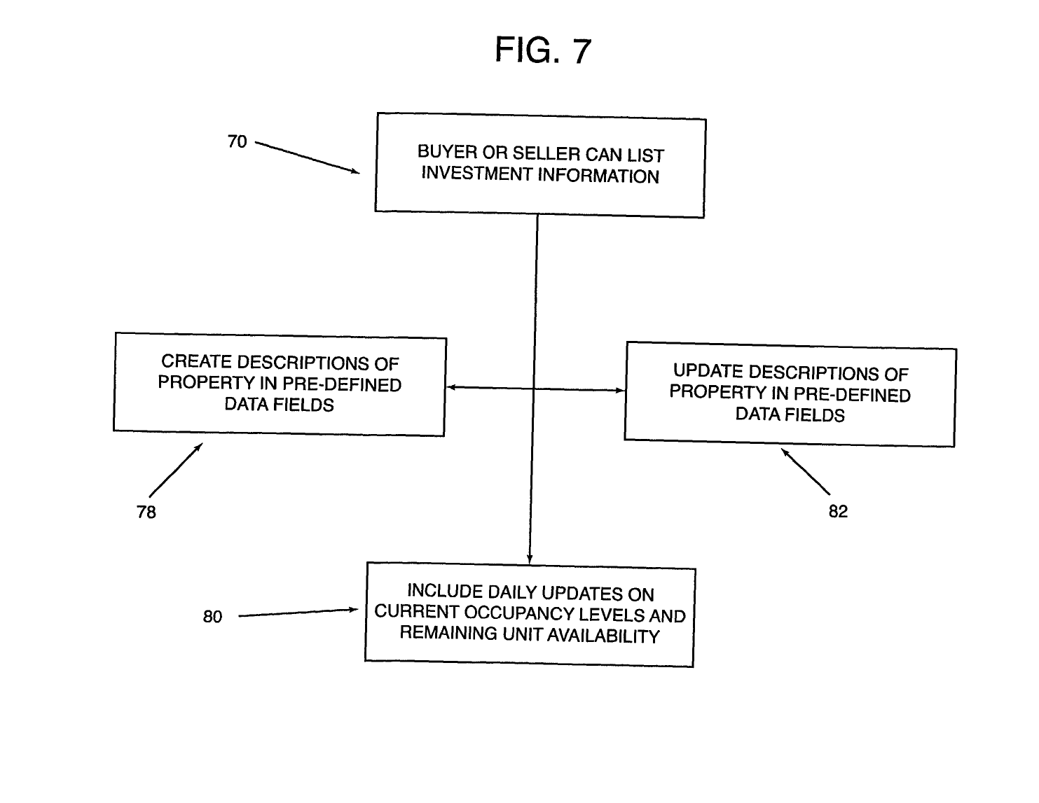

FIG. 7 is one embodiment of the path following the buyer or seller listing investment information option 70. This option is available for sellers of tax credits, or for those looking to purchase tax credits meeting certain criteria. Sellers can list investment information on their investment properties. In listing their property for buyers and tenants alike, sellers can use the site to create descriptions of their property in pre-defined data fields 78, update descriptions of their property in pre-defined data fields 82, or include daily updates on current occupancy levels and remaining unit availability 80. This information may be used for parties interested in bidding on any tax credits relating to the property, and for informing prospective tenants and buyers in the consumer information section. Thus, in this embodiment, sellers may go to this area to add to or change the description of their property for both the commercial transaction area and the consumer information area.

In one embodiment, prospective buyers and tenants may also use this option in order to list information regarding tax credits they are looking to purchase, or housing they are searching for. For instance, a prospective buyer may be looking for a certain number of tax credits relating to historical properties in Iowa. They can list that information in the form of creating and updating descriptions, just as a seller may do. In one embodiment, prospective tenants may similarly list descriptions of single or multiple family dwellings they may be searching for in a certain area for a certain price.

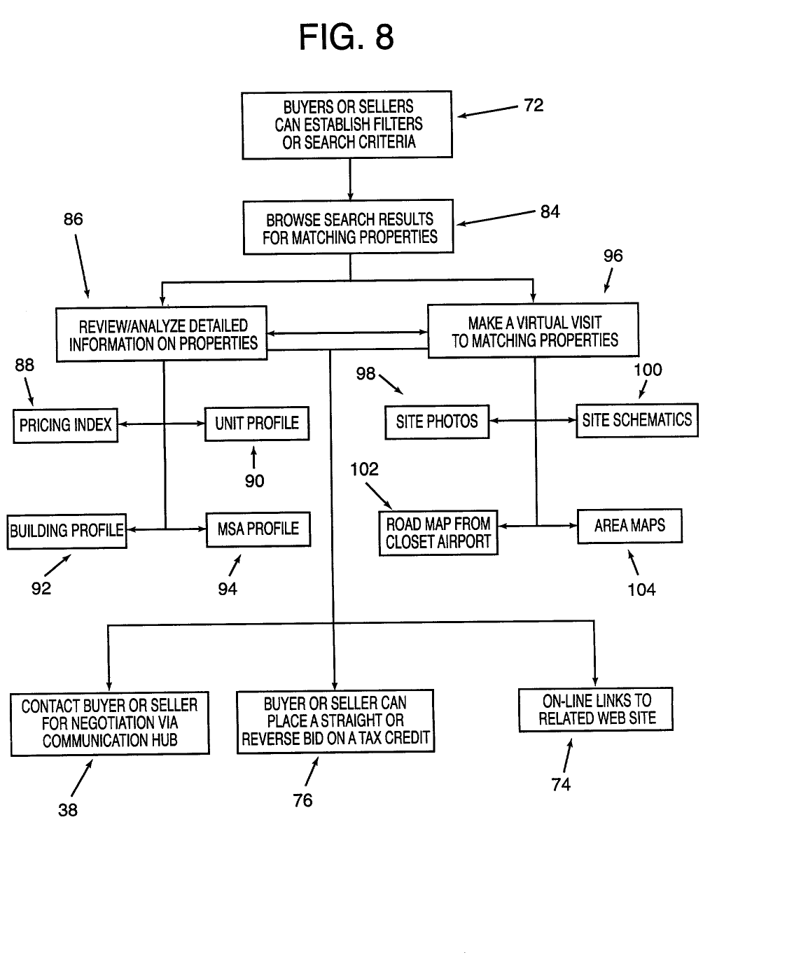

In FIG. 8, one embodiment of the path following a selection of the option for a prospective buyer or seller to establish search criteria 72 is shown. When a user enters this area, they can search for tax credits related to investment properties by state, city, zip code, or telephone area code. Additional optional “filters” or search criteria may include, but are not limited to: 1) acquisition choice (indirect (i.e., buy from syndicators) versus direct (buy from developers/owner)), 2) choice of stipulated up front cash position (e.g., other than the purchase price, zero cash outlay for the first x years), 3) choice of stipulated net present value, 4) minimum face value for credit dollar amount, 5) unit types (single or multi-family dwellings), 6) number of units, 7) square feet per unit, 8) contract rent, 9) utility allowance, 10) gross rent, 11) city population-renters and households, 12) city's population by age groupings, 13) city's household ownership by age, 14) monthly contract rent spreads (less than, more than), 15) value of owner occupied housing in city (less than, more than), 16) rental units and/or multi-family units permitted since 1990 in the city, 17) number of comparable properties for comparable rental data, 18) request for references for local housing studies, rental surveys or vacancy surveys, 19) request for employment information (names/number of employees of three to five major employers in the area (job titles for typical employees, starting or average wage)), 20) request for other supporting information (qualified census tracts by local county, rent and income limits by local county), 21) implicit interest rate, and 22) developer's references (names, phone numbers, prior projects, etc.).

Once the filters or search criteria have been established 72, search results may be displayed and the user may then be allowed to browse those search results for matching properties 84. After selecting matching properties, the user may be presented with two options. In this embodiment, the user my either review and analyze detailed information on the properties 86, or make virtual visits to the matching properties 96.

In one embodiment of the present invention, the search criteria can be saved on the server 28, and the software located on the server 28 can continue to search the database 30 for updated properties that may match the user's search criteria after the user leaves the site. If a matching property is located while the user is not on the site, an email alert message can be instantly sent to the user to notify them of the new matching property.

If the user selects to review and analyze detailed information on the properties 86, they may be presented with options. In this embodiment, those options are: pricing index 88, unit profile 90, building profile 92, and Metropolitan Statistical Area (MSA) profile 94.

The pricing index option 88 may give many points of information to the user. In one embodiment, the pricing index gives five options. The first is a representative area index of what comparable tax credits have recently sold for as a percentage of award value. The second is acquisition method (indirect (i.e., buy from syndicators) versus direct (buy from developers/owner)). A third piece of information given in the pricing index 88 is the up front cash position (e.g., other than the purchase price, zero cash outlay for the first x years). A fourth piece of information given in the pricing index is the net present value. A fifth piece of information given in the pricing index is the face value for credit dollar amount.

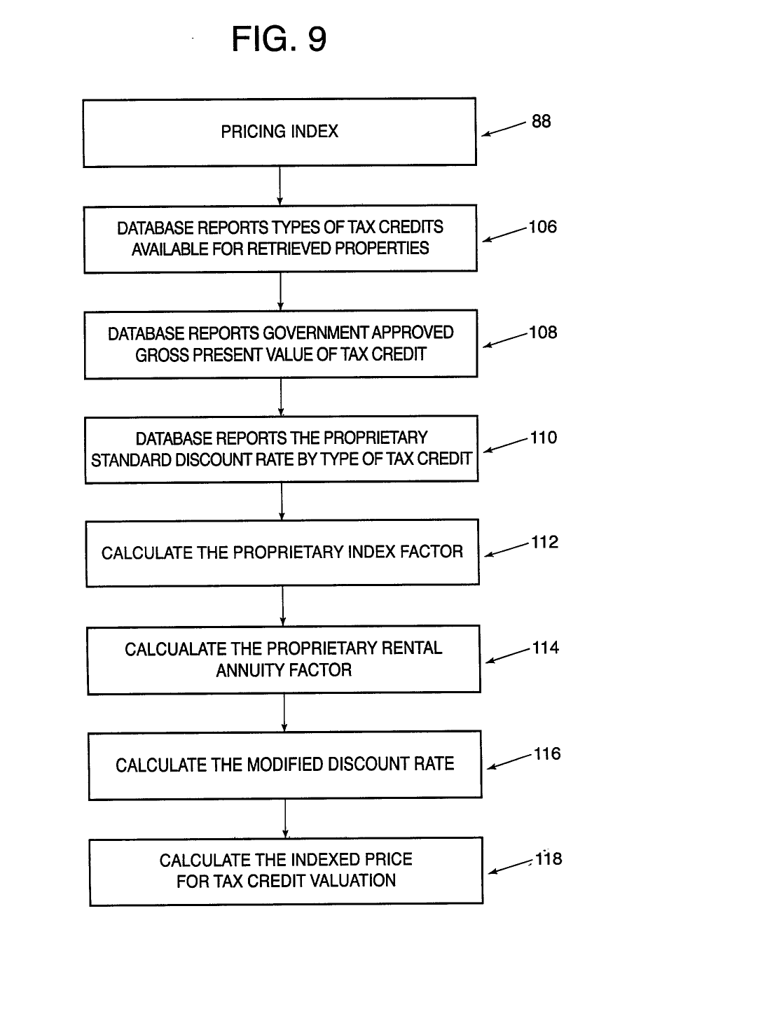

In FIG. 9, one embodiment of the index pricing system 88 is shown. Once the pricing index option 88 has been selected, the data base 30 reports the applicable type of tax credits issued by the taxing authority 106. The tax credits may be either state or federal, and may be either for historic or low-income level properties. The data base 30 then reports the applicable issuing tax authority's published gross value of the tax credits 108. The data base then reports the standard discount rate by type of tax credit 110. In this embodiment of the invention, a standard discount rate specific to each type of tax credit can be assigned on a quarterly basis. The present invention then calculates the index factor 112. The index factor for each previously retrieved property can be calculated based on the ratio of construction cost per square foot as a percentage of the applicable local market's monthly average real estate sector resale price. Then a rental annuity factor can be calculated 114. The rental annuity factor for each previously retrieved property can be calculated based on surveyed forecast of occupancy rates in the applicable market. Depending on the surveyed forecast of occupancy rates, a quarterly adjusted factor can be assigned in one embodiment as follows:

| Surveyed forecast of Occupancy Rate | Assigned Factor |
|---|---|
| 95-100% | 0.020 |
| 90-94% | 0.015 |
| 85-89% | 0.010 |
| 80-84% | 0.005 |
| 79% and below | 0.000 |

After the rental annuity factor has been calculated 114, the modified discount rate can be calculated 116. The modified discount rate 116 for each previously retrieved property is calculated based on multiplying the standard discount rate (reported in block 110) times the index factor (block 112). This product can then be added to the rental annuity factor (block 114). The resulting sum is called the modified discount rate 116. The indexed price for the tax credit valuation can then be calculated 118. The indexed price for the tax credit valuation 118 is calculated for each previously retrieved property based on multiplying the modified discount rate (block 11 6) times the applicable issuing tax authority's published present gross value of the tax credits (block 108). The product is called the index price for tax credit valuation 118, and can be used by prospective buyers or sellers as a bench mark or guide to begin tax credit price negotiations with other buyers or sellers.

Referring back to FIG. 8, another option presented to the user under the analyzing detailed information on properties 86, is reviewing the unit profile 90. Under this option, information can be displayed, such as the property identification number and the structure type, the unit types(1, 2, 3 bedrooms, bath, etc . . . ), the number of units, and the square feet per unit. Under the building profile option 92, information such as contract rent, utility allowance, and gross rent can be presented. Under the Metropolitan Statistical Area (MSA) profile option 94, information such as economic trends in the community, population demographics, labor force demographics, school types (K-12, junior/senior highschool, etc.), monthly contract rent spreads (less than, more than), value of owner occupied housing in city (less than, more than), rental units and/or multi-family units permitted since 1990 in the city, comparable rental data (three cops/name/address/city/phone/photo, number of units, breakdown by number of bedrooms, monthly contract rent), references for local housing studies, rental surveys, or vacancy surveys, employment information (names/number of employees of three to five major employers in the area (job titles for typical employees, starting or average wage)), other supporting information (qualified census tracts by local county, rental and income limits by local county) may be displayed.

In one embodiment, instead of reviewing or analyzing detailed information on properties 86, the user may choose as a result of search results 84 to make a virtual visit to matching properties 96. Under this option, users are able to make virtual visits to selected properties to view site photos 98, site schematics 100, directional road maps from the closest airport 102, or area maps 104. In one embodiment, regardless of whether the user has chosen to review or analyze detailed information of the properties 86 or to make a virtual visit to matching properties 96, from either point, the user may select one of four other options. In one embodiment these options are to contact a seller for negotiations via the communication hub 38, to place a straight or reverse bid on a property 76, to use an online link to a related site 74, or to jump to the other search result option. For instance, a user who selected to make a virtual visit to matching properties (block 96) may then elect to review detailed information on the property (block 86).

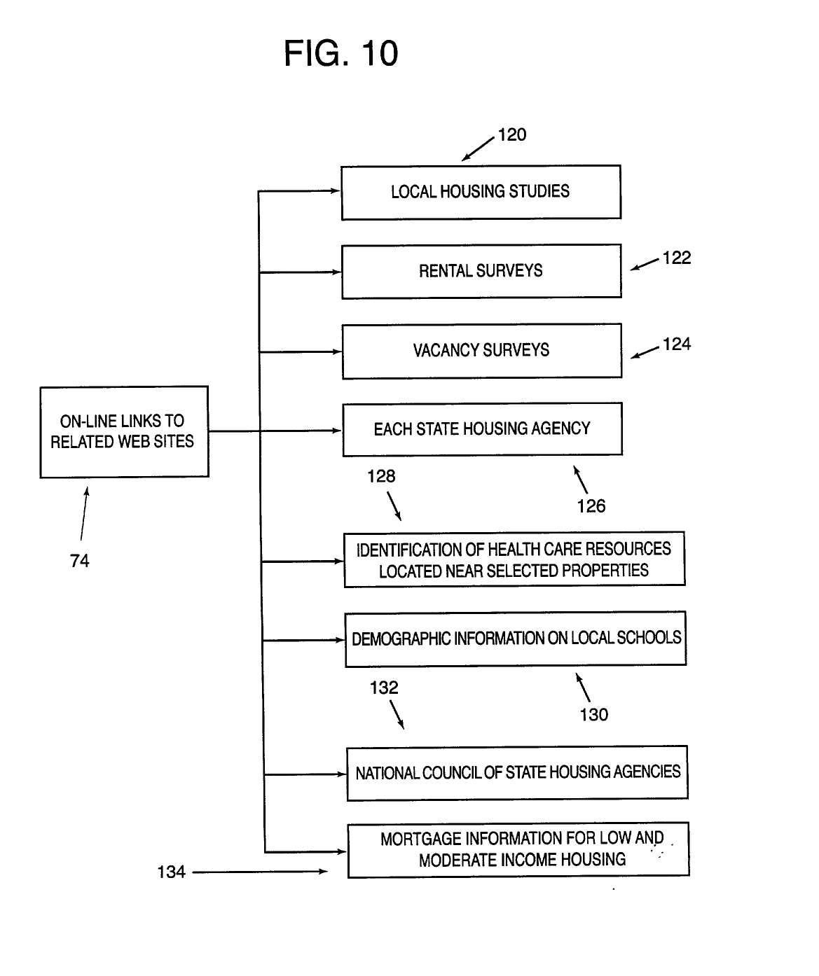

FIG. 10 shows one embodiment of the invention in which a user may link to related web sites 74. This option may be presented to the user initially when the commercial transaction section has been selected 66, as shown in FIG. 6, and may also be available to the user after either reviewing detailed information on properties 86, or making a virtual visit to a matching property 96, as shown in FIG. 8. Under this option, users are able to find links to related web sites for such things as: local housing studies 120, rental surveys 122, vacancies surveys 124, each of the 50 state housing agency web sites 126, identification of health care resources located near selected properties 128, demographic information on local schools 130, the National Council of State Housing Agencies 132, and mortgage information for low and moderate income housing 134. These options are exemplary, and should not be used to restrict the scope of the invention.

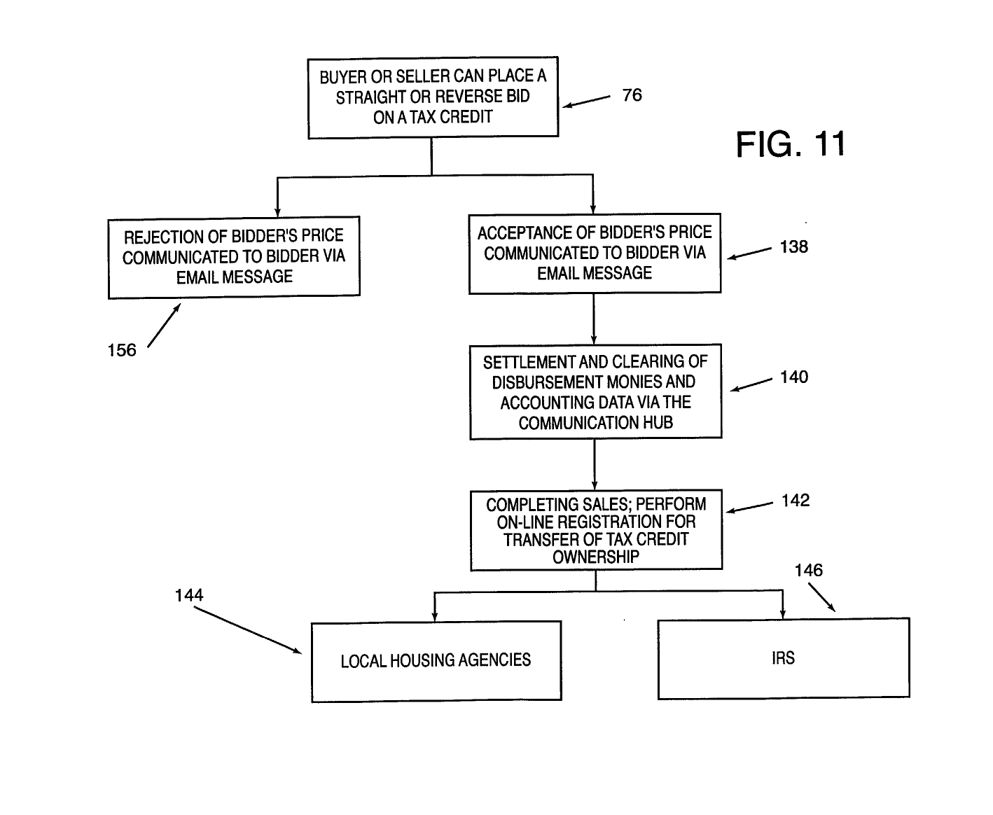

In one embodiment, a final option presented to the user upon entering the commercial transaction section 66 may be to place a straight or reverse bid on a tax credit 76 as shown in FIG. 6. In one embodiment, bids may be made by one of two methods. In a first method, known as a straight auction, buyers may bid on seller listed tax credits that have been retrieved by the invention's database as a result of buyer-defined filters that are matched with available tax credits. In a second method, known as a reverse auction, a seller may bid on buyer listed purchase orders for tax credits that have been retrieved from the invention's database as a result of seller-defined filters that are matched with available purchase orders for tax credits. This option may also be available as shown in FIG. 8 as presented to a user after either reviewing detailed information on a property 86, or making a virtual visit to a matching property 96. FIG. 11 shows one embodiment of the present invention where a user can place a straight or reverse bid on tax credits 76. In one embodiment, the user first selects the option to place a straight or reverse bid on tax credits 76. When this happens, the user can then select a button to enter an online bid to buy or sell the tax credits at a price of their choosing. In one embodiment of the invention, once a bid has been placed, the server may send an alert email message to the buyer or seller to notify them that a bid has been made. Also, once the bid is made, other users may be able to see that bid amount, and a bidder may bid as many times as they wish. Once a bid has been entered, the bid can be either rejected 136 or accepted 138. In one embodiment, confirmation of the buyer or seller's acceptance or rejection can be delivered via an e-mail message to the seller within a specified time, such as 24 hours. If the buyer or seller fails to respond to a bidder's offer within the allotted time, such an action could constitute a rejection and the bidder would be notified within a specified time, such as 24 hours, of the rejection 136. In the event that the buyer or seller accepts the bid, an e-mail message confirming the acceptance could be communicated to the buyer or seller 138, and a hold could be placed on the buyer's credit card account in the amount of the bid price plus applicable transaction fees and an IRS local housing authority ownership transfer registration fee. In one embodiment, initial acceptance of a bidder's price could result in the real estate property tax credits being flagged on the system with a “conditionally sold” status. Once a property has been flagged as “conditionally sold”, no other bids would be allowed. If for any reason, such as breakdown in closing negotiations, or failure to make funds available, or inadequate proof of title, the “conditionally sold” status could be removed, and the tax credits could once again become available to prospective bidders.

In one embodiment, the transaction between the buyer and seller could then be consummated offline, and a formal real estate closing to transfer ownership documents, warranties, payments, etc. could be conducted. In another embodiment, the settlement and clearing of disbursement monies and accounting data could be conducted on-line 140. This could be done using the internet data call option 51 in the communication hub 38. In this situation, the buyer and seller could be routed to a specific site having automated clearinghouse transaction capabilities, where all routing information, bank data, etc. could be processed. This could be advantageous in a situation where a bundle of deals is being completed at once. This would eliminate the need for a buyer to write multiple checks and sign multiple papers.

After completing the sale, the buyer and seller may perform online registration for transfer of tax credit ownership 142. The registration may be with the local housing agencies 144, and/or the IRS 146. The online registration could be done via the internet email option 48 of the communication hub 38, or a hotlink may be provided to a registration site.

### Consumer Information Section

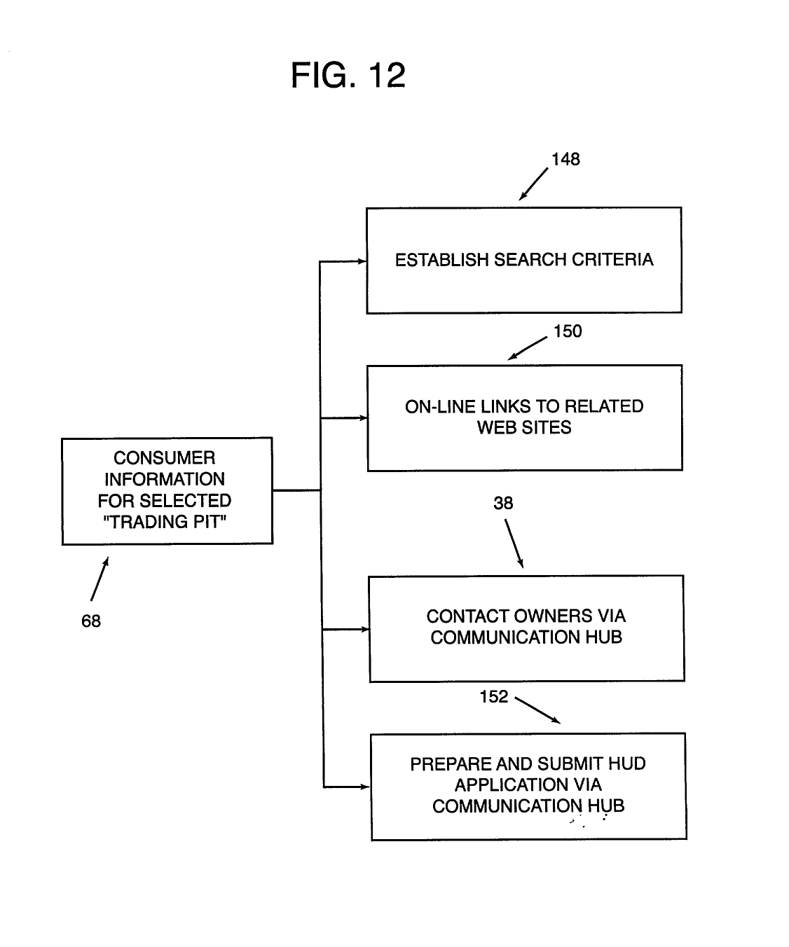

In one embodiment of the invention, once the user has selected a specific trading pit in the electronic marketplace 42, they could select the consumer information section 68. FIG. 12 shows the overall schematic of the consumer information section 68 for one embodiment of the invention. After choosing the consumer information section 68, the user could be presented with options. These options include: allowing prospective buyers and renters to establish filters or search criteria 148, allowing the user to select on-line links to related web sites 150, allowing prospective buyers or renters to contact the owners of the property via the communication hub 38, and allowing prospective buyers or renters to prepare and submit housing applications, such as a HUD application 152, via the internet email option 48 of the communication hub 38.

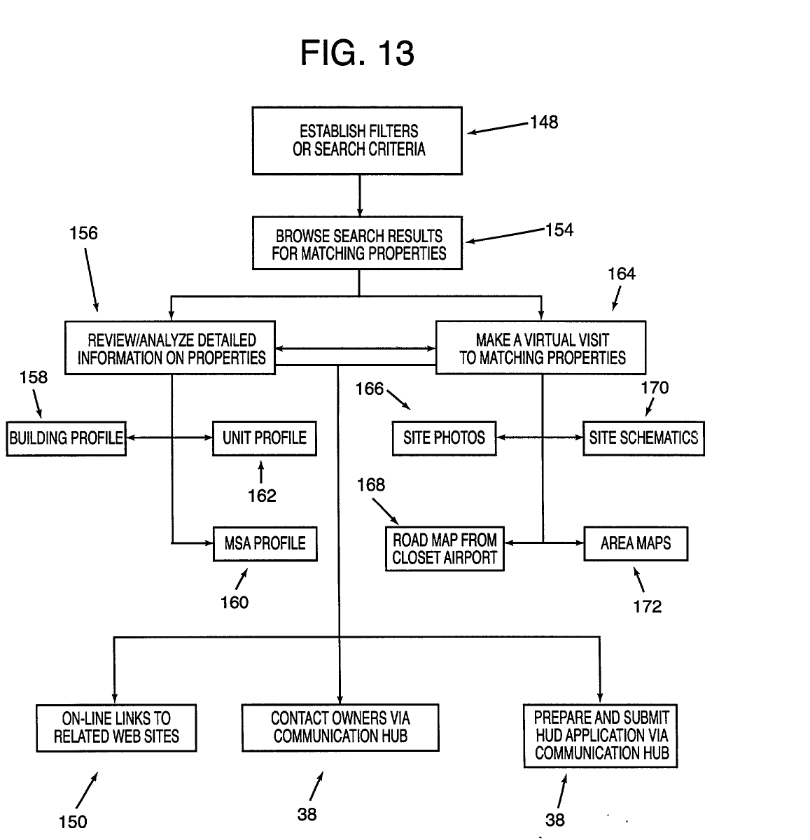

In FIG. 13, one embodiment of the path following a selection of the option for a prospective buyer to establish search criteria 148 is shown. When a user enters this area, they can search for investment properties by state, city, zip code, or telephone area code. Additional optional “filters” or search criteria may include, but are not limited to: 1) unit types (single or multi-family dwellings), 2) number of units, 3) square feet per unit, 4) contract rent, 5) utility allowance, 6) gross rent, 7) city population-renters and households, 8) city's population by age groupings, 9) city's household ownership by age, 10) monthly contract rent spreads (less than, more than), 11) value of owner occupied housing in city (less than, more than), 12) rental units and/or multi-family units permitted since 1990 in the city, 13) number of comparable properties for comparable rental data, 14) request for references for local housing studies, rental surveys or vacancy surveys, 15) request for employment information (names/number of employees of three to five major employers in the area (job titles for typical employees, starting or average wage)), 16) request for other supporting information (qualified census tracts by local county, rent and income limits by local county), and 17) stipulation of number of bedrooms, number of bathrooms, and amenities .

In one embodiment, once the filters or search criteria have been established 148, search results may be displayed and the user may then be allowed to browse those search results for matching properties 154. After selecting matching properties, the user is presented with two options. The user may either review and analyze detailed information on the properties 156, or make virtual visits to the matching properties 164.

In one embodiment of the present invention, the search criteria can be saved on the server 28, and the software located on the server 28 can continue to search the database 30 for updated properties that may match the user's search criteria after the user leaves the site. If a matching property is located while the user is not on the site, an email alert message can be instantly sent to the user to notify them of the new matching property.

If the user selects to review and analyze detailed information on the properties 156, they may be presented with options, such as unit profile 162, building profile 158, and Metropolitan Statistical Area (MSA) profile 160.

In one embodiment, an option presented to the user under the analyzing detailed information on properties 156, may be reviewing the unit profile 162. Under this option, information can be displayed, such as the property identification number and the structure type, the unit types(1, 2, 3 bedrooms, bath, etc.), the number of units, and the square feet per unit. Under the building profile option 158, information such as contract rent, utility allowance, and gross rent can be presented. Under the Metropolitan Statistical Area (MSA) profile option 160, information such as economic trends in the community, population demographics, labor force demographics, school types (K-12, junior/senior highschool, etc.), monthly contract rent spreads (less than, more than), value of owner occupied housing in city (less than, more than), rental units and/or multi-family units permitted since 1990 in the city, comparable rental data (three cops/name/address/city/phone/photo, number of units, breakdown by number of bedrooms, monthly contract rent), references for local housing studies, rental surveys, or vacancy surveys, employment information (names/number of employees of three to five major employers in the area (job titles for typical employees, starting or average wage)), other supporting information (qualified census tracts by local county, rental and income limits by local county) may be displayed.

In one embodiment, instead of reviewing or analyzing detailed information on properties 156, the user may choose as a result of search 154 to make a virtual visit to matching properties 164. Under this option, users may make virtual visits to selected properties to view site photos 166, site schematics 170, directional road maps from the closest airport 168, or area maps 172. In one embodiment, regardless of whether the user has chosen to review or analyze detailed information of the properties 156 or to make a virtual visit to matching properties 164, from either point, the user may select one of three other options. In one embodiment these options are to contact a seller or owner for negotiations via the communication hub 38, to use an online link to a related site 150, or to prepare and submit a housing application, such as a HUD application via the internet email option 48 of the communication hub 38.

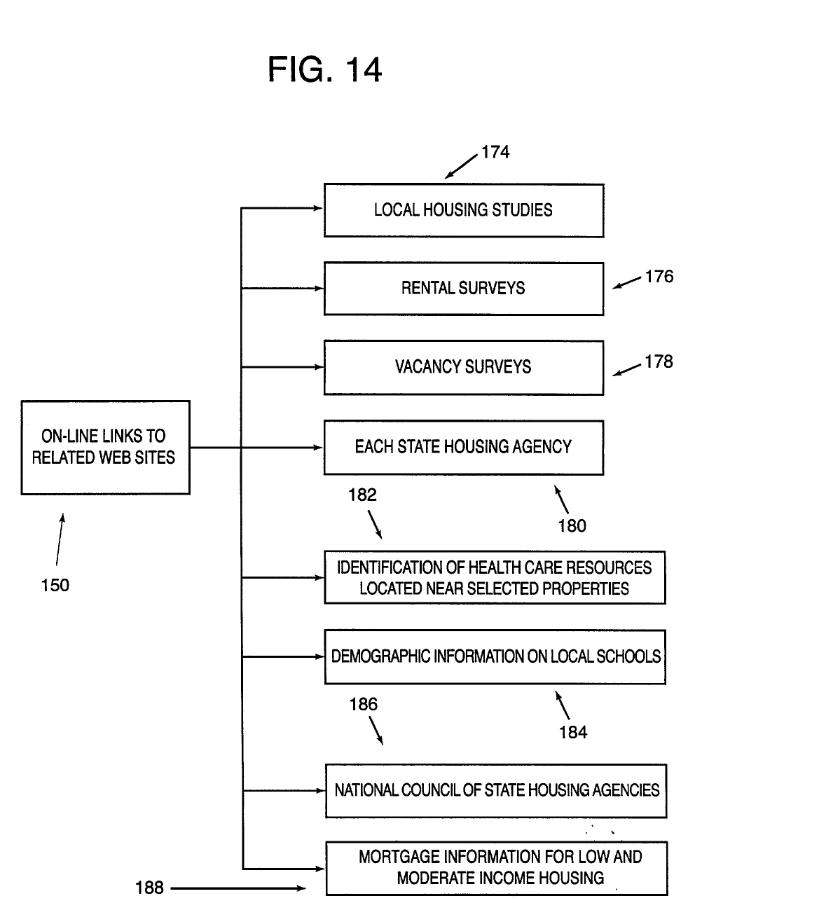

FIG. 14 shows one embodiment of the invention in which a user may link to related web sites 150 from the consumer information section 68. This option may be presented to the user initially when the consumer information section has been selected 68, as shown in FIG. 12, and/or may be available to the user after either reviewing detailed information on properties 156, or making a virtual visit to a matching property 164, as shown in FIG. 13. Under this option, users are able to find links to related web sites for such things as: local housing studies 174, rental surveys 176, vacancies surveys 178, each of the 50 state housing agency web sites 180, identification of health care resources located near selected properties 182, demographic information on local schools 184, the National Council of State Housing Agencies 186, and mortgage information for low and moderate income housing 188. These options are exemplary, and should not be used to restrict the scope of the invention.

### General Information Center

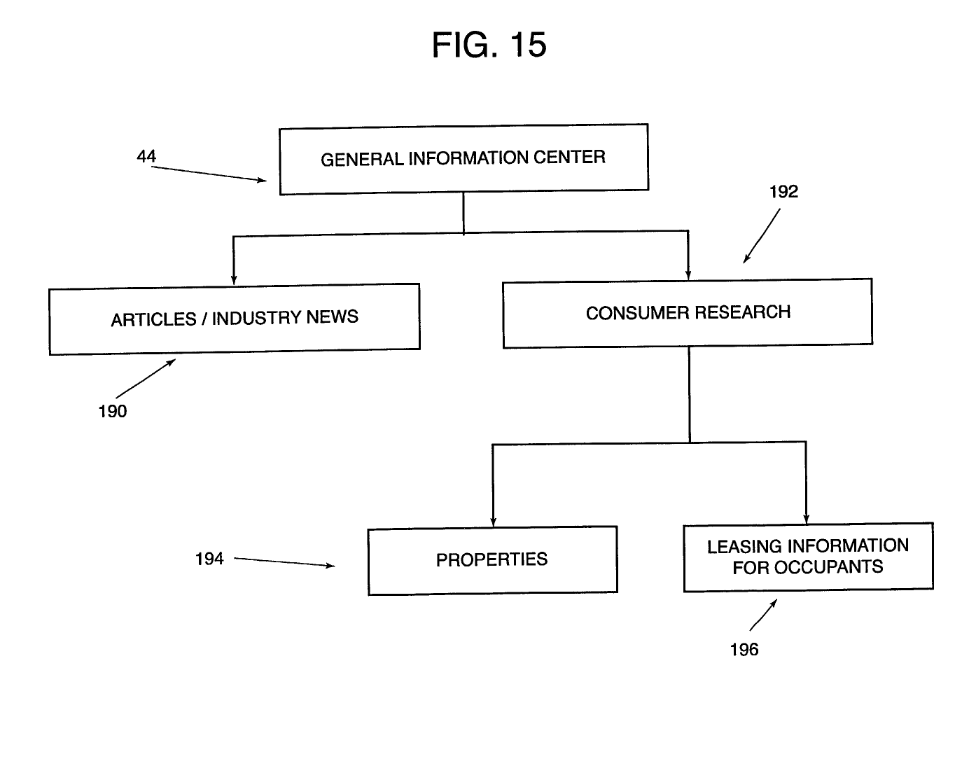

FIG. 15 shows one embodiment of the present invention in which a user can find general information regarding the industry, properties, and leasing information. At the entry point of the site, as shown in FIG. 2, a user may select the general information center option 44. The user may then select to view articles and other forms of industry news 190 regarding the website, the tax credit industry, the housing industry, etc.. The user may alternatively select a consumer search option 192. In one embodiment, under this option, a user could access information regarding properties 194 they are considering, or occupants could access leasing information 196. These options are exemplary, and should not be used to restrict the scope of the invention.

### Advantages

One advantage of the present invention, is that it provides online research of a variety of investment property highlights, including local housing finance agency project numbers, development names and cities, the owner or contact of the housing tax credits requested and the housing tax credits awarded, all in one location. There are also listings for tax credit based commercial properties such as those located in federally recognized empowerment zones. Another advantage of this invention is that it is a secondary market or clearinghouse for buyers and sellers to come together to trade tax credits in an efficient and profitable manner. Bidders are allowed to bid more than once and are allowed to see the latest bids after having had an opportunity to research the properties related to the tax credits, and speak with the buyer or seller via an on-line connection.

Information search efforts are simplified. The present invention is a time efficient methodology for the astute buyer or renter to accurately gather, analyze, and shortlist options based on a tailored set of criteria. The search is conducted on-line with information accurately and instantaneously retrieved. A buyer or renter's criteria template is formed on-line and is easily integrated with seller property profiles and pricing. This makes for easy comparison of needs versus available inventory of tax credits and/or housing. There is no paperwork nightmare. A user could electronically go through the criteria template and download the results into their hard drive for storage, future retrieval, or printing of pertinent details. Buyer's can find housing and tax credits that best fit their needs, and can reduce time by conducting a majority of their business on-line. Also, sellers can find buyers looking for tax credits meeting certain criteria. Buyers and sellers of tax credits can register their tax credit ownership transfer on-line, saving significant time. Similarly, prospective tenants can fill out housing applications on-line. Advertisers can create hotlinks to their web sites for additional information, and for on-line sales. Owners of investment properties can create and update customized listings of their property, and have this information available to users 24 hours a day and 7 days a week.

The accompanying Figures described above depict embodiments of the present invention, and features and components thereof. With regard to references in this specification to computers, the computers may be any standard computer including standard attachments and components thereof (e.g., a disk drive, hard drive, CD player or network server that communicates with a CPU and main memory, a sound board, a keyboard and mouse, and a monitor). The processor of the CPU in the computer may be any conventional general purpose single- or multi-chip microprocessor such as, but not limited to, a Pentium® processor, a Pentium® Pro processor, a 8051 processor, a MIPS® processor, a Motorola Processor, a Power PC® processor, a Celeron 500 processor, or an ALPHA® processor. In addition, the processor may be any conventional special purpose processor such as a digital signal processor or a graphics processor. The microprocessor may have conventional address lines, conventional data lines, and one or more conventional control lines. With regard to references to software, the software may be standard software used by those skilled in the art or may be coded in any standard programming language to accomplish the tasks detailed above and below.

The Internet is widely used today for a variety of applications. The Internet is a collection of computer networks that allows computer users to share files and other computer resources. Each computer connected to the Internet has a unique address whose format is defined by the Internet Protocol (“TCP/IP”). The Internet includes a public network using the TCP/IP and includes two kinds of computers: servers, which provide information and documents; and clients, which retrieve and display documents and information for users. As will be appreciated by those of ordinary skill in the art, as used throughout this specification the term “client” refers to a client computer (or machine) on a network, or to a process or programs, such as Web browsers, which run on a client computer in order to facilitate network connectivity and communications. This specification uses the term “individual” or “user” when referring to a person using a client computer to access the server and enter usage information. Similarly, the term “server” as used throughout this specification to refers to a server computer or computer system on a network, including the database attached to the server for storing information.

The system and method of the invention may use the “World Wide Web” (“Web” or “WWW”), which is that collection of servers on the Internet that utilize the Hypertext Transfer Protocol (“HTTP”). HTTP is a known application protocol that provides users access to resources, which may be information in different formats such as text, graphics, images, sound, video, Hypertext Markup Language (“HTML”), as well as programs. Upon specification of a link by the user, the client computer makes a TCP/IP request to a Web server and receives information, which may be another “Web page” that is formatted according to HTML. Users can also access other pages on the same or other servers by following instructions on the screen, entering certain data, or clicking on selected icons. It should also be noted that any type of selection device known to those skilled in the art, such as check boxes, drop-down boxes, and the like, may be used for embodiments of the invention using web pages to allow a user to select options for a given component. Servers run on a variety of platforms, including UNIX machines, although other platforms, such as Windows 2000, Windows NT, Sun, Linux, BeOS, and Macintosh may also be used. Computer users can view information available on servers or networks on the Web through the use of browsing software, such as Netscape Navigator, Microsoft Internet Explorer, Mosaic, or Lynx browsers. A typical Web page is an HTML document with text, “links” that a user may activate (e.g. “click on”), as well as embedded URL's pointing to resources, such as images, video or sound, that the client may activate to fully use the Web page in a browser. Furthermore, HTTP allows for the transmission of certain information from the client computer to a server. The server can then post this information on its web site, forward it on to another user or server, or save it to a database for later use.

While the present invention has been described with reference to several embodiments thereof, those skilled in the art will recognize various changes that may be made without departing from the spirit and scope of the claimed invention. Accordingly, this invention is not limited to what is shown in the drawings and described in the specification but only as indicated in the appended claims, nor is the claimed invention limited in applicability to one type of computer or computer network. Any numbering or ordering of elements in the following claims is merely for convenience and is not intended to suggest that the ordering of the elements of the claims has any particular significance other than that otherwise expressed by the language of the claims.

We claim:

1. A computer-implemented method for buying and selling tax credits, the method comprising:
a) a first user posting information regarding the tax credits;
b) a second user bidding for the sale of the tax credits via a communication path; and
c) the first user accepting or rejecting the bid.

2. The method of claim 1, wherein the first user is an owner of the tax credits, and the second user is a prospective buyer of the tax credits.

3. The method of claim 1, wherein the second user is an owner of the tax credits, and the first user is a prospective buyer of the tax credits.

4. The method of claim 1, further comprising the users selecting a trading pit in which to trade the tax credits.

5. The method of claim 4, wherein the trading pit is selected from the group consisting of: affordable housing, commercial property, historic property, educational property, and industrial property.

6. The method of claim 1, further comprising allowing the users to list investment information regarding tax credits and investment properties on one database.

7. The method of claim 1, further comprising allowing the first and second users to make contact via an on-line communication.

8. The method of claim 7, wherein the on-line communication is selected from the group consisting of: an internet phone call, an internet electronic mail message, an internet fax message, and an internet data call transmission.

9. Th method of claim 1, wherein a third user can electronically see the bid made by the second user.

10. The method of claim 1, wherein the second user may submit multiple bids.

11. The method of claim 1, wherein the first party communicates the rejection or acceptance to the second party via an e-mail message.

12. The method of claim 1, further comprising the users performing on-line registration for transfer of the tax credit ownership.

13. An apparatus for facilitating the trade of tax credits, comprising a server containing instructions for
a) receiving tax credit information from a first user;
b) receiving tax credit information from a second user; and
c) facilitating trade of the tax credits between the first user and the second user.

14. The apparatus of claim 13, wherein the first user is a buyer and the second user is a seller.

15. The apparatus of claim 13, wherein trade of the tax credits is accomplished by an auction means.

16. The apparatus of claim 13, further comprising a means for researching properties.

17. The apparatus of claim 13, further comprising a means for the users to communicate.

18. A computer-implemented method for consumers to find available properties, the method comprising:
a) a first user listing information on a property;
b) a second user conducting an electronic search for properties;
c) the second user selecting the property; and
d) the first and second user consummating the transaction on-line.

19. The method of claim 18, further comprising the second user electronically preparing and submitting a housing application.

20. The method of claim 18, further comprising the second user electronically conducting research on the property.
